(19) United States
(12) Patent Application Publication
(10) Pub. No.: US 2025/0045119 A1
(43) Pub. Date: Feb. 6, 2025

(54) OPTIMIZED DEPLOYMENT OF CLOUD NATIVE WORKSPACES AND JOBS ACROSS MULTIPLE INFRASTRUCTURES FOR HIGH SCALABILITY AND PERFORMANCE

(71) Applicant: Dell Products L.P., Round Rock, TX (US)

(72) Inventors: Shamik Kacker, Austin, TX (US); Bijan Kumar Mohanty, Austin, TX (US); Hung Dinh, Austin, TX (US); Thiagarajan Ramakrishnan, Round Rock, TX (US)

(21) Appl. No.: 18/365,484

(22) Filed: Aug. 4, 2023

(51) Int. Cl. G06F 9/50; G06N 3/09

(52) U.S. Cl. CPC G06F 9/5055; G06N 3/09

(57) ABSTRACT

One example method includes receiving, by a workspace size predicting engine, a workspace provisioning request regarding a customer machine learning (ML) model, predicting, by the workspace size predicting engine, a size of a workspace that corresponds to the workspace provisioning request, receiving, by a datacenter host prediction engine from the workspace size predicting engine, the workspace size, and predicting, by the datacenter host prediction engine, a datacenter and/or host that is able to support requirements of the workspace.

### FIELD OF THE INVENTION

Embodiments of the present invention generally relate to machine learning (ML) models. More particularly, at least some embodiments of the invention relate to systems, hardware, software, computer-readable media, and methods, for deployment of an ML model in a supporting infrastructure.

### BACKGROUND

The data analytics and Machine Learning (ML) subfield of Artificial Intelligence (AI) is growing rapidly across all industries and shifted away from an academic research context to practical and real-world applications. Successfully building and serving ML models in production requires large amounts of data, compute power, and infrastructure. Cloud native architectures and contributions by the data science community including tools like JupyterHub, RStudio, MLFlow, and Metaflow, has made ML more accessible, flexible, and cost-effective for data practitioners and infrastructure administrators/IT to train and deliver ML capabilities. Many of these tools/workspaces are available to run on local workstations or deployed as a container on Kubernetes, one of the popular container orchestration frameworks in the industry.

Kubernetes provides a way to run real world applications across different environments, including multiple datacenters, and may help end users to abstract the underlying infrastructure, thus allowing end user applications to be deployed and scaled up across disparate environments such as on-prem datacenters, public cloud, private cloud, or hybrid environments. However, even with rich extension of tools and extensions such as federations, deploying and extending these Kubernetes clusters across multiple datacenters and regions requires meticulous planning, configuration, and monitoring to ensure appropriate uptime, performance, fault tolerance and consistency of these systems.

However, AI/ML workspaces with current technology to scale up and down CPU, memory and storage would not suffice. Certain AI/ML workloads can be very resource-intensive and may require specialized hardware such as GPUs (graphics processing unit) or TPUs (tensor processing units) to process large amounts of data in real-time. While the functional aspects and expectations of AI/ML workspaces and jobs are deterministic, the nonfunctional requirements/expectations such as performance, security and reliability drastically changes at scale. For example, non-functional requirements define how a system should perform when 1000 users are accessing a workspace simultaneously, and millions of jobs are running concurrently at the same time, while continuing at the same time to provide a seamless experience to data practitioners.

Software architects and IT (information technology) administrators are not well equipped and trained to consider different architectural constraints well in advance to deploy and schedule these AI/ML workspaces and jobs across multiple regions/hosts/environment or datacenters in advance. If the architects, business units, and enterprises, fail to adapt their use case to these constraints in advance, it leads to a disruptive experience for end users of the ML models, and imposes a maintenance overhead for the platform team.

Further, incorrect scheduling and/or placement of these workspaces and jobs can lead to several problems including, for example, uneven distribution of workloads across datacenters that results in suboptimal utilization of computing resources, performance degradation of machines which increases network latency during data ingestion or inferencing modeling results, increases the operational costs, and causes compliance and security risks for the business. To understand how to deploy machine learning tools and platforms, it is important to know how customers are utilizing these deployed tools and accessing these frameworks, and then construct infrastructure systems so that they would are robust, cost-effective, easily maintainable, and effectively manage the resources for the business.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a physical infrastructure of Domino.

FIG. 2 discloses an AWS Sagemaker Notebook.

FIG. 3 discloses Sagemaker resource pricing.

FIG. 4 discloses an architecture to build, train and deploy ML models on Microsoft Azure.

FIG. 5 discloses Vertex AI Workbench Offerings.

FIG. 6 discloses a hypothetical architecture illustrating various problems.

FIG. 7 discloses an end-to-end architecture relating to the example of FIG. 6.

FIG. 8 discloses a JupyterHub landing page.

FIG. 9 discloses a multi-cluster JupyterHub deployment.

FIG. 10 discloses an overall architecture according to an example embodiment.

FIG. 11 discloses a table of inputs and associated targets according to an embodiment.

FIG. 12 discloses another table of inputs and associated targets according to an embodiment.

FIG. 13 discloses aspects of a workspace size prediction engine according to an embodiment.

FIG. 14 discloses aspects of a DNN according to one example embodiment.

FIG. 15 discloses example code for generating a data frame, according to an embodiment.

FIG. 16 discloses example code for encoding non-numerical data of a dataset, according to an embodiment.

FIG. 17 discloses example code for splitting a dataset, according to an embodiment.

FIG. 18 discloses example code for building a DNN according to an embodiment.

FIG. 19 discloses example code for compilation and training of a model according to an embodiment.

FIG. 20 discloses example code for obtaining a prediction by a workspace size prediction engine.

FIG. 21 discloses aspects of a host prediction engine according to an embodiment.

FIG. 22 discloses the architecture of an example neural network for host prediction, according to an embodiment.

FIG. 23 discloses example code for generating a data frame, according to an embodiment.

FIG. 24 discloses example code for importing packages and libraries for data engineering, data pre-processing, label encoding, and model building activities, and also discloses example code for loading a historical dataset that includes information about the datacenter(s) where workspaces were previously deployed, and information concerning execution and telemetry of those workspaces.

FIG. 25 discloses example code for encoding non-numerical data of a dataset, according to an embodiment.

FIG. 26 discloses example code to build a neural network of a host prediction model, according to an embodiment.

FIG. 27 discloses example code for evaluation of the performance of a host prediction model according to an embodiment.

FIG. 28 discloses an example method according to an embodiment.

FIG. 29 discloses an example computing entity configured and operable to perform any of the disclosed methods, processes, and operations.

### DETAILED DESCRIPTION OF SOME EXAMPLE EMBODIMENTS

Embodiments of the present invention generally relate to machine learning (ML) models. More particularly, at least some embodiments of the invention relate to systems, hardware, software, computer-readable media, and methods, for deployment of an ML model in a supporting infrastructure.

In one example embodiment, systems and methods are provided that determine configuration and deployment constraints in advance prior to offering them as a service to end users, such as ML models for example. In an embodiment, an AI/ML resource knowledge base is created with information about what model training and serving configurations customers typically from a group utilize, what kinds of data the customer typically uses to build these ML models. In an embodiment, a DNN (Deep Neural Network) may be deployed alongside reinforcement learning techniques, to ensure that workspaces are deployed on the right datacenter and jobs are scheduled at appropriate times so as to enable IT teams to efficiently deploy resources and manage workloads. As well an embodiment may offer practitioners an instance at a datacenter personalized to their requirements, thus avoiding disruptions irrespective of where the underlying infrastructure is hosted, such as on-prem or in a cloud environment.

In more detail, an example embodiment may comprise a two-step process in which the first step, or operation, comprises identifying an optimum size of a workspace and predicting the compute, memory and storage size of that workspace. In the second step of this example embodiment, these parameters of the workspace may be used to identify the environment(s) in which to build the workspace for optimal behavior of the ML model to be deployed in the workspace. In an embodiment, the environment may include the datacenter name, and a host name for building the workspace. In both these steps, an embodiment of the invention may operate to leverage ML algorithms, and also train the ML algorithms using historical environment utilization metrics and workspace provisioning data.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an example embodiment of the invention is that the capacity of an environment to support an ML model workspace may be evaluated in advance before deployment of the ML model. An embodiment may account for ongoing changes to resource needs of an ML model workspace when evaluating an environment for possible placement of the workspace. An embodiment may predict the resource requirements for an ML workspace. An embodiment may predict the size of an environment needed to support an ML workspace. An embodiment may identify resource characteristics of a workspace that is being provisioned so that the workspace may be scheduled in an appropriate environment. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. CONTEXT FOR AN EXAMPLE EMBODIMENT OF THE INVENTION

The data science and machine learning community has a diverse range of experience in working with live systems. Though building, developing and deploying ML systems has become widespread, the task of maintaining and managing them cumbersome and challenging. The data that is used for model training and model inferencing changes over time where existing data may become outdated during new data addition. This involves having security and compliance regulations in check for the data that is newly added into their workspace. Business requirements can also evolve, which leads to retraining models with additional data and features to the existing model after hyperparameter tuning, or may even require updating the data to a whole new model. These modeling updates can impact the production environments as data practitioners look for versioning the model alongside data, testing, and deployment strategies to ensure a seamless experience for end users of the model.

Various machine learning techniques also have disparate respective sets of infrastructure requirements. For example, running massive sized neural networks and managing massive training datasets to derive meaningful insights would require specialized compute and storage resources. For example, bagging and boosting algorithms like Adaboost, Gradient Boosting, Xgboost and Catboost algorithms are usually CPU-intensive while ML algorithms like K-nearest neighbors, Random Forest and Naïve Bayes are 10 intensive.

These ML use cases are experimental and iterative in nature and multiple samples of these experiments are facilitated by cross validation and grid search techniques to pick optimal hyperparameters. However, it may be useful to have these modelling updates, training and inference metrics directly aligned with the business. Few of these ML experiments can be parallelized in the infrastructure while sequentially serving this intelligence to end users, which calls for different sets of management and coordination with the infrastructure.

Production ML applications deployed in different environments, whether on-premises, cloud or edge, may require changes in the infrastructure to accommodate these scenarios. Such changes may include scaling up or down the compute resources, changing storage configurations, updating networking setups, launching jobs or GPU or CPU accelerated environments or migrating to new infrastructure technologies.

Overall, maintaining ML systems requires continuous efforts to monitor, debug, optimize, secure, collaborate and deploy these instances across disparate environments. This leads to increase complexity and leads to having specialized skills, tools, best practices, and processes to ensure the stability of ML systems in production. It is not unusual for organizations to hire and train dedicated machine learning engineers, infrastructure engineers, product application security groups and architects to carefully analyze, in advance, if the resources allocated and performance of these data centers are stable. However, while relying on domain experts to alert and make changes is useful, such an approach is fragile in terms of its ability to accommodate time-sensitive issues, and this approach is problematic at scale since a human domain expert is imply not capable of performing these analyses in an accurate and timely manner.

Assuming that these organizational and hiring challenges are overcome to hire SMEs across various business units, and entities have stood up AI/ML workspaces with dynamic CPU, memory and storage values, and there exists an appropriate datacenter for data practitioners to pre-process data and build ML models, aspects of some of the current initiatives incorporating cloud native architectural design are provided as comparative examples with one or more embodiments of the invention, and briefly discussed below.

### A.1 Architecture by Domino Data Labs

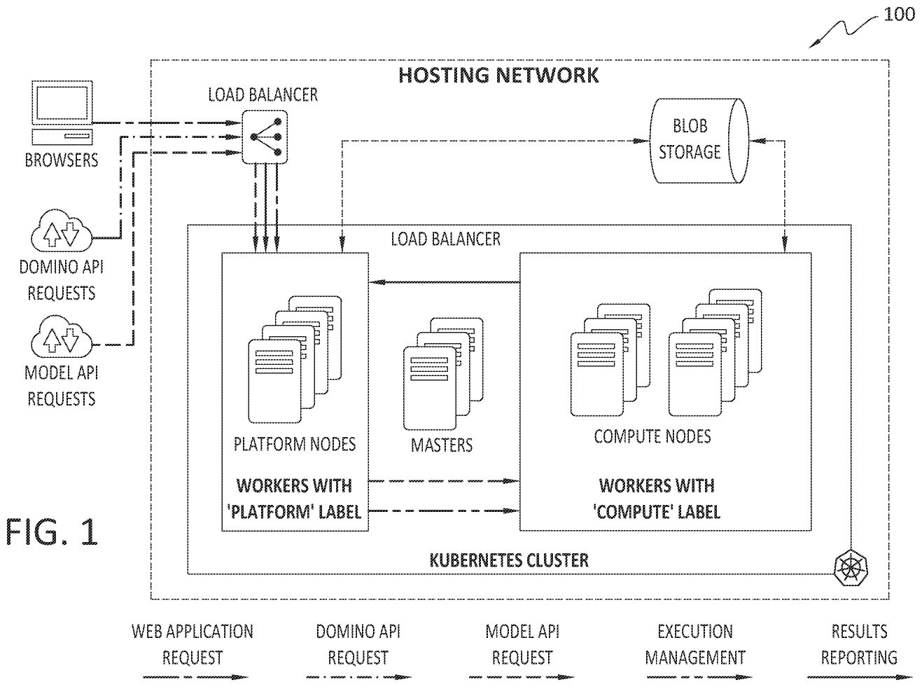

With reference to FIG. 1, a physical infrastructure of Domino Data Labs is indicated at 100. In all workloads in Domino applications run as containerized process orchestrated by Kubernetes. It has two major workloads: Domino Platform—provides user interfaces, API servers, orchestration, metadata and supporting services; and, Domino Compute—data science, engineering and ML workloads are executed. As explained in the Domino Data Lab Admin Guide, outside of the cluster, Domino has a durable blob storage system and a load balancer to regulate connections from users. Users in Domino assign their executions to Hardware Architecture. Number of resources like cores, cores limit, memory, memory limit, number of GPUs are assigned by Domino based on the hardware tier that the user chose. Notably, no expertise is provided on how to provision these resources across multiple data centers.

### A.2 Reference Architecture by Amazon Sagemaker

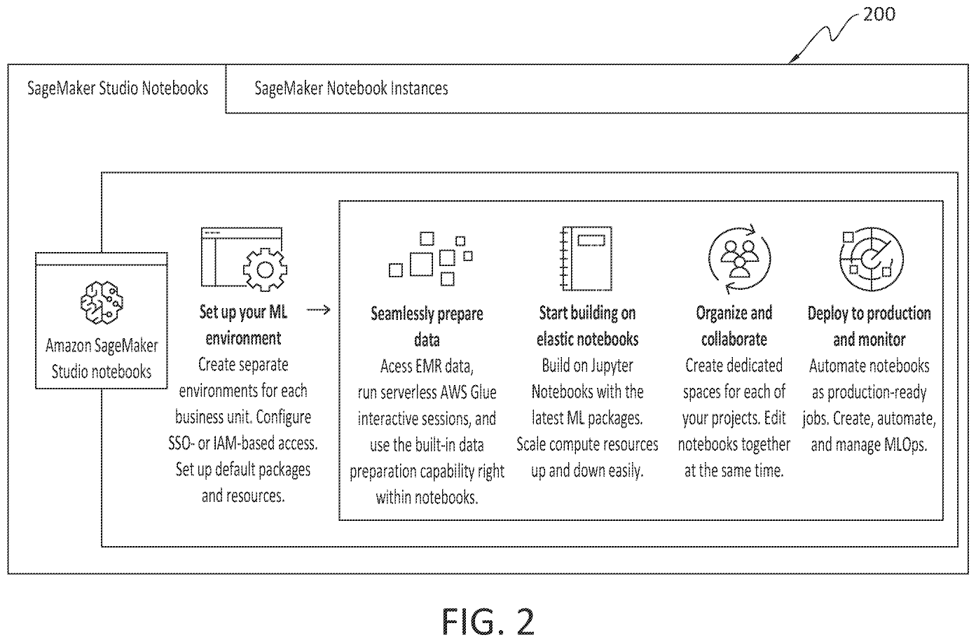

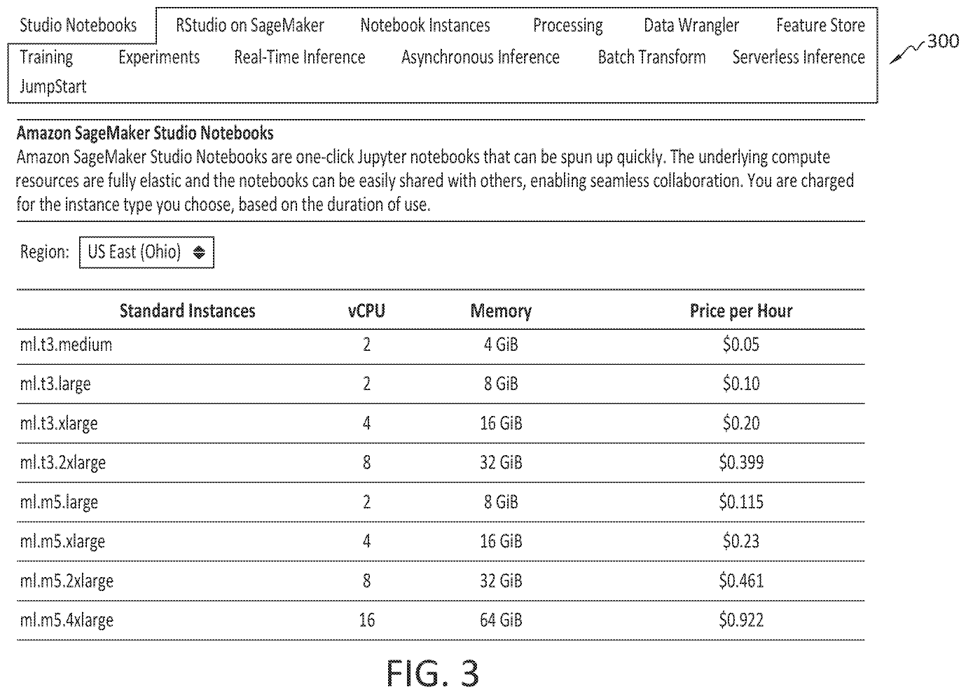

With reference now to FIG. 2, an AWS (Amazon Web Services) Sagemaker Studio Notebook is denoted at 200. Cloud providers such as AWS offer Sagemaker notebooks. These fully managed notebooks are used for exploring data, training and deploying (ML) models on AWS cloud. As shown in FIG. 3, which discloses Sagemaker resource pricing information, AWS Sagemaker users are offered a selection 300 of compute and storage resources that would be necessary to handle their AI/ML workloads. As shown, users are given the option to pick the right region to deploy their instance. Notably however, the users are not provided with any guidance as to whether that region is appropriate or not for their particular use case.

### A.3 Reference Architecture by AzureML

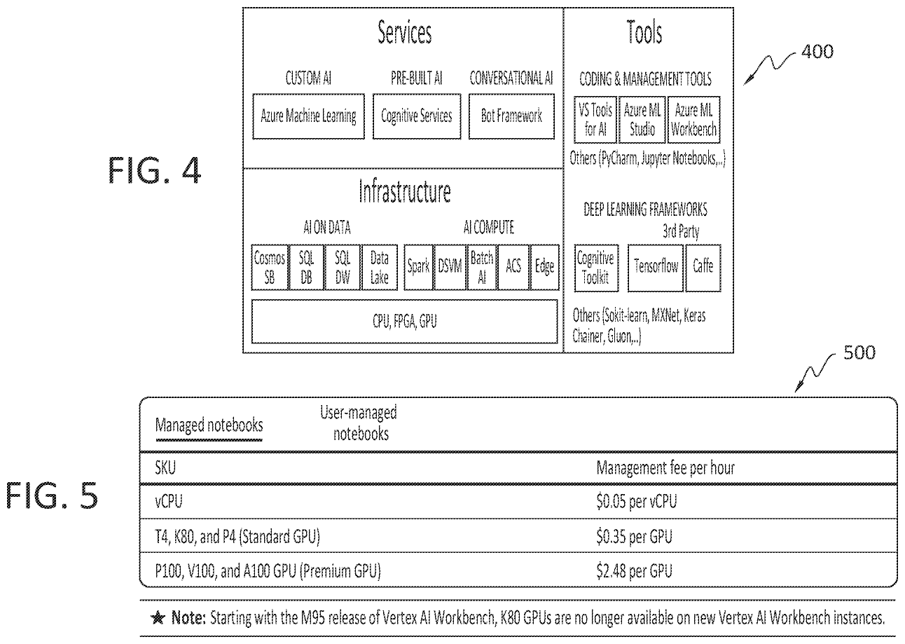

With reference to FIGS. 4, there is shown an architecture 400 to build, train and deploy ML models on Microsoft Azure. Microsoft Azure ML platform is a fully managed platform to build, deploy and manage models at scale. As summarized in the AzureML Documentation, Jupyter notebooks and other AI/ML workspaces are offered with pre-configured resources in their offerings. The AzureML workspace is the Microsoft top-level resource for all machine learning activities, and provides their end users a centralized place to view and manage the artifacts that are generated while using their product. Similar to AWS, Azure also provides an option to select a region where users would have their workspace spun up on.

### A.4 Reference Architecture by Google Cloud

With reference to FIG. 5, there is shown Vertex AI Workbench Offerings 500. Particularly, FIG. 5 captures Vertex AI Workbench Management fees in addition to infrastructure usage. Vertex AI Managed notebooks with pre-configured compute and storage resources are charged at the same rate as a customer pays for compute engine and cloud storage offerings.

### B. EXAMPLE PROBLEMS THAT MAY BE ADDRESSED BY AN EMBODIMENT OF THE INVENTION

Data scientists and architects need to decide on what is the best possible approach to fetch data, build models and run inference on top of the pre-built model. Data scientists must be an expert in Containers, Kubernetes, Data Security, Endpoints, Scaling, Persistent Volumes, GPUs DevOps, Programming in new languages, and tools, for example. While some approaches may help data practitioners to dynamically allocate the right set of resources for their AI/ML workspaces deployed on cloud-native infrastructures like Kubernetes, the data practitioner would still need to decide on which data center or infrastructure it should be deployed under.

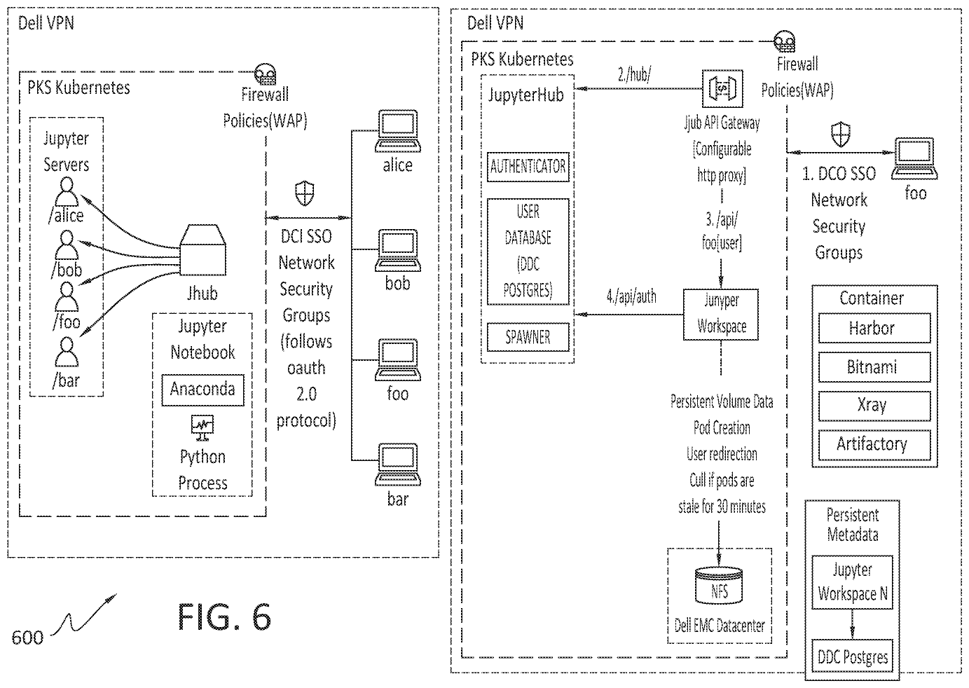

As data practitioners aspire to operate at scale to improve their model accuracy and have recurrent feedback loops back and forth various components in the data platform stack, the resource constraints need to be elastic with minimal disruption from IT administrators. However, conventional workspaces and AI/ML jobs that customers would launch do not have appropriate burst capacity to train ML models or serve them in production with appropriate security and monitoring guard rails. FIG. 6 is illustrative of these problems, as it discloses an architecture 600 that is used for deploying AI/ML applications as containers on top of Kubernetes, but which lacks features such as those just noted.

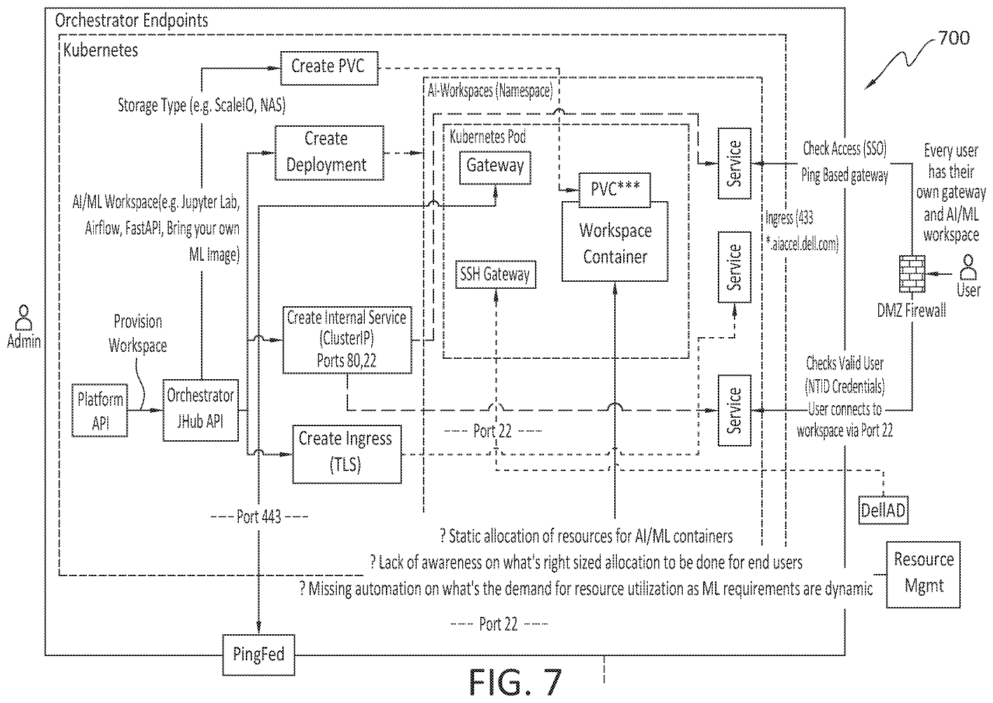

With reference now to FIG. 7, there is shown an end-to-end architecture 700 in which a set of Kubernetes APIs are deployed on top of clusters. As captured in FIG. 7, container images are securely fetched from a registry such as Harbor and deployed using CI/CD solutions such as Gitlab. The environment variables necessary to deploy these applications are fetched from vault during runtime. If there are any open-source packages that need to be leveraged for running certain AI/ML workloads, they are fetched from a JFrog artifactory. The data currently stored in AI/ML workspaces are accessible across multiple clusters via network attached storage component (NFS). Some of the artifacts relevant to ML also are stored and retrieved from ECS object store.

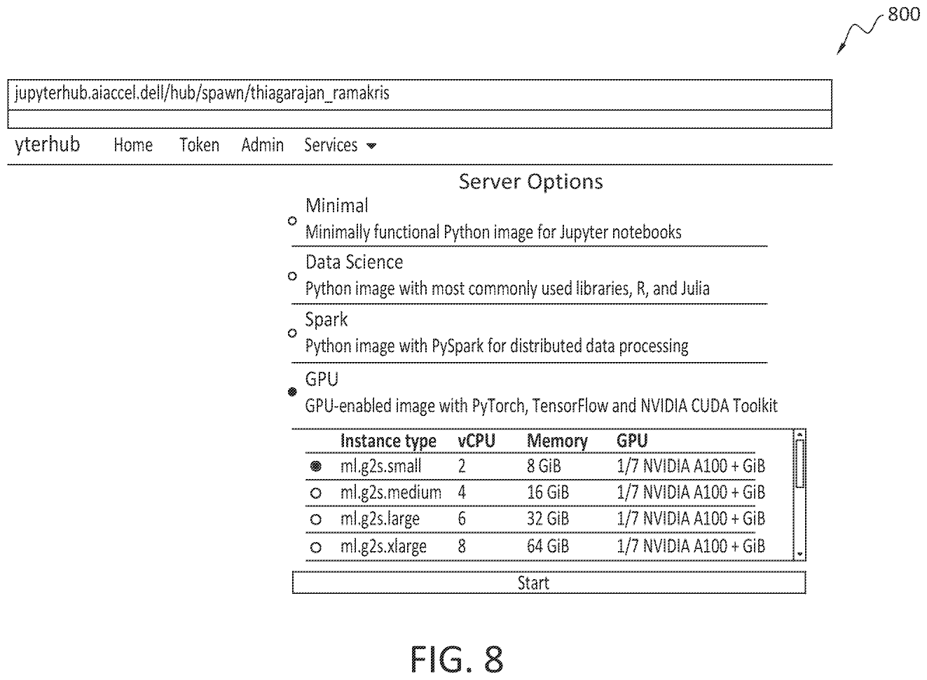

Turning next to FIG. 8, there is shown a sample landing page 800 of Jupyter Notebooks provisioned within a JupyterHub instance on a certain datacenter. However, no provision is made for making a decision with respect to selecting the right infrastructure for their personalized use-case.

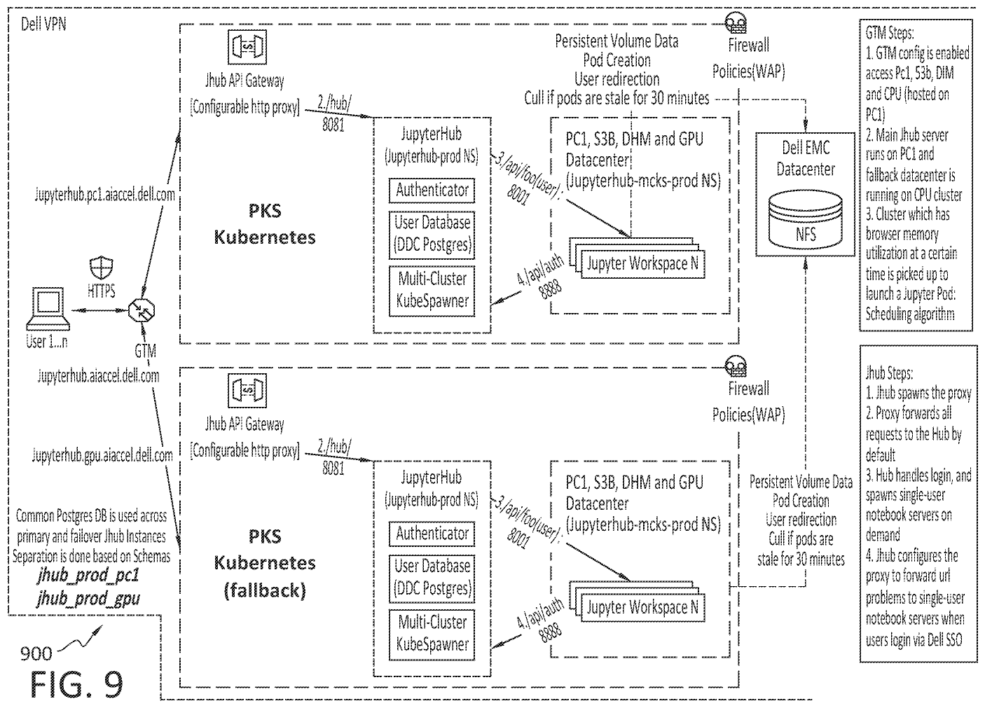

FIG. 9 discloses one possible architecture 900 for enabling AI/ML workspaces to be deployable across multiple clusters. While there is a simplistic way to launch these workspaces and jobs on top of the cluster based on resource utilization, this approach fails to address the dynamic nature of these ML algorithms and business requirements which still need to be accounted by IT and infrastructure stakeholders.

As illustrated in FIGS. 1 through 9, there are at least three fundamental problems with the approaches shown in those Figures, any one or more of which may be addressed by one or more example embodiments of the invention. One of such problems is the static determination of infrastructure, in which AI/ML workspaces or jobs are provisioned to data practitioners in round robin or other pre-defined mechanisms across the datacenters. Because these determinations are static, they fail to account for changes in the AI/ML workspaces, or for changes in the environments where those AI/ML workspaces are placed. Another problem is that these approaches required manual intervention for scaling. It is not unusual for companies to hire dedicated IT administrators to decide on migrating workspaces or scheduling jobs on different datacenters based on utilization or business requirement to optimize the cost for their business, while keeping user experience consistent. Such manual approaches are simply unable timely and accurately to account for ongoing changes in the AI/ML workspaces, or for changes in the environments where those AI/ML workspaces are placed. A human is unable to predict, or react to, such changes in a timely and technically adequate manner. As well, these manual approaches are prone to introduction of human errors. A final problem is that such approaches fail to provide process automation for optimizing workspace and job scheduling. Choosing the right datacenter to deploy an AI/ML application is challenging, and system administrators are not able to keep up with the demand and utilization of resources for a single team of data practitioners, much less for multiple, larger, teams.

### C. DETAILED DESCRIPTION OF AN EXAMPLE EMBODIMENT OF THE INVENTION

### C.1 Overview

An example embodiment of the invention comprises a method for predicting the size of workspace from an infrastructure perspective based on the requirements of the workspace. The method may then identify an appropriate environment, such as host/pod/datacenter for example, in which to build the workspace. This environment may be identified based on various considerations such as, but not limited to, the available resource and processing capacity of the environment, as well as the predicted future growth of the environment.

Because the capacity of an environment, whether on-premises or in the cloud, may fluctuate and demand for the environment resources may, an embodiment of the invention may schedule the workspace in the appropriate environment for maximizing the performance, scalability, and robust growth in the future, of the ML model to be run in that environment. As ML models vary, their need for type/amount of resources may also vary. While some models are CPU intensive, other models may be memory or IO intensive. For example, while NNs or NLP (natural language processing) using transformers may need GPUs or NPUs (neural processing units), shallow learning algorithms such as ensemble decision trees, SVM (support vector machine) or even linear regression/classification may work well with CPUs only. As these examples illustrate, the selection of environments may be important to the efficient processing and management of the ML workspaces.

Thus, an embodiment of the invention may select an environment for an ML workspace using a two-step process, in which the first step comprises identifying the optimum size of the workspace, and predicting the compute, memory and storage size, of that workspace. The second step, which may be performed based on these predictions and the optimum size of the workspace, is to build the workspace for optimal behavior of the ML model. The ML workspace may then be placed in the environment for execution. In an embodiment, the environment may include the datacenter name and host name for building the workspace. In both these steps, an embodiment of the invention leverages ML algorithms to perform one or both of the first step and the second step, and train the ML algorithms using historical environment utilization metrics and workspace provisioning data.

### C.2 Example Architecture According to One Embodiment of the Invention

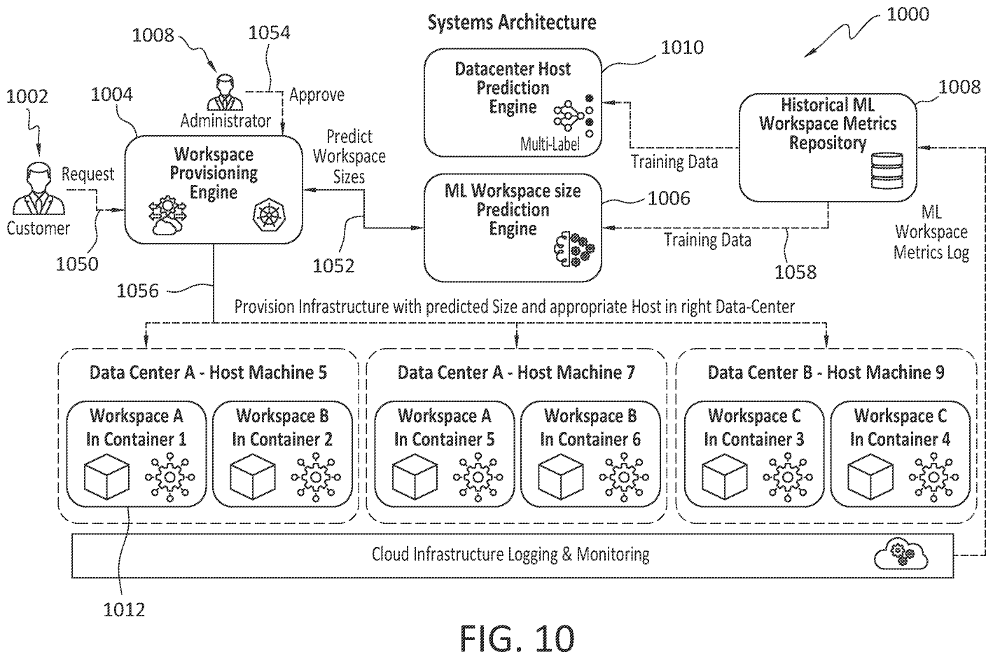

With attention now to FIG. 10, an example architecture, and associated methods and operations, according to one embodiment of the invention are denoted at 1000. As shown, customers 1002 may access a workspace provisioning engine (WPE) 1004, which may comprise an element of a platform for provisioning ML workspaces in which an ML model or ML algorithm is to be run. Note that as used herein an ‘ML model’ or ‘model,’ may comprise, among other things, an ‘ML algorithm’ that is executable to obtain various results.

To access the WPE 1004, the customer 1002 may send a request 1050 to the workspace provisioning engine component 1004, such as by calling an API or sending the details of the required workspace in a JSON format. The request 1050 may include, for example, information such as the type of ML algorithm to be run in the workspace, the size of a training dataset for the ML algorithm, the number of users working on the workspace, and the type of use, such as production or non-production, of the required workspace. In an embodiment, the request 1050 may ultimately result in creation and provisioning of a new workspace, or modification of an existing workspace in terms of its provisioning.

This information in the request 1050 may be passed 1052 to an ML workspace size prediction engine (WSPE) 1006, which may comprise an algorithm that predicts, based on the information in the request 1050, the number of containers, compute, and storage size of each container. Upon being approved 1054 by a platform admin 1008, these details may be used by the WPE 1004 to provision an optimal workspace size corresponding to the request 1050. In an embodiment, the WPE 1004 may use Kubernetes functions for provisioning the number of containers with the size as predicted by the WSPE 1006.

Briefly then, the example architecture 1000 according to one embodiment of the invention may be implemented to comprise various components. These components may include the WPE 1004, a historical ML workspace metrics repository (WMR) 1008, the WSPE 1006, and a datacenter and host prediction engine (DHPE) 1010. These components, which may each comprise a respective ML model to carry out their respective functions, are considered in turn below.

### C.2.1 Aspects of an Example WPE

In an embodiment, the WPE 1004 comprises a workflow that receives the workspace requirement features requested 1050 by the customers 1002 of the platform, and utilizes the WSPE 1006 to get the optimal value(s) of the workspace, such as the number of containers, and the processing and memory needs of each container. After the WPE 1004 predicts the size of the workspace needed, a platform administrator may approve 1054 the workspace size, although such approval is not required in every case. Upon approval 1054 of the workspace size, the WPE 1004 components may call the necessary APIs (application program interface) of Kubernetes, or another platform capable of automated deployment, scaling, and management of containerized applications, and then pass 1052 the predicted size to the WPE 1004 for provisioning 1056 of the necessary workspace, such as workspace 1012 for example, in the shared platform.

### C.2.2 Aspects of an Example WMR

In an embodiment, the historical ML workspace metrics data, stored in the WMR 1008, may be the best indicator for predicting, with high accuracy, what would be the most optimal workspace size for a future ML workspace. In an embodiment, the WMR 1008 may comprise a data repository that harvests workspace infrastructure metrics data from a cloud native shared platform and filters the unnecessary variables out of that data.

In an embodiment, data engineering and data pre-processing may be done early to enable an understanding of the features and the data elements that will be influencing the predictions for infrastructure size of the workspace. This analysis may include, for example, multivariate plots and correlation heatmap to identify the significance of each feature in the dataset so that un-important data elements are filtered. This filtering may be performed at/by the WMR 1008. The filtering may help to reduce the dimensionality and complexity of an ML workspace prediction model, such as may be included in the WSPE 1006 for example, thus improving the accuracy and performance of the ML workspace prediction model.

In an embodiment, the WMR 1008 may contain important information including, but not limited to, the type of ML algorithm used in the workspace, workspace domain, size of training data, number of users using the system, type of use such as production or non-production, as well as the average compute, storage and IO utilization of the workspace, along with the response/target variables such as, but not limited to, the number of containers and compute and memory size of each container. This information may be supplied 1058 as training data to the WSPE 1006, as discussed in more detail below.

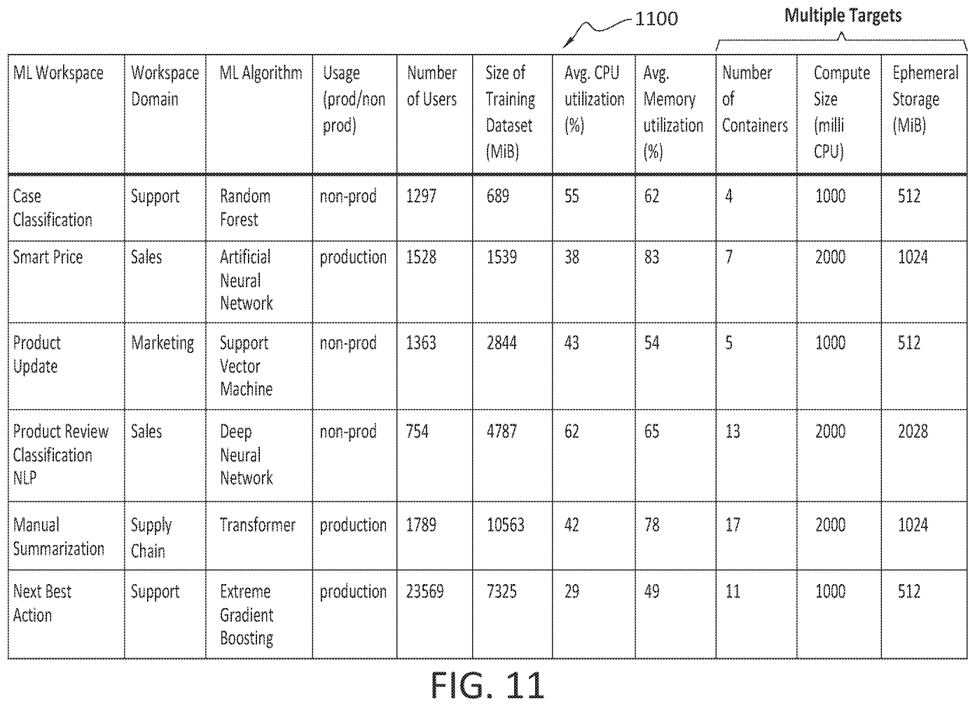

With continued reference to FIG. 10, and directing attention now to FIG. 11 as well, a table 1100 is disclosed that comprises example data elements that may be stored in the WMR 1008 and used for training the model in the WSPE 1006. It is noted, with regard to the example of table 1100, that the table 1100 comprises an example subset of attributes, not all of which may be required to train the model of the WSPE 1006. In an embodiment, the column data ‘Avg. CPU utilization (%)’ and the ‘Avg. Memory Utilization (%)’ may not need to be used as features for training the model of the WSPE 1006. As also indicated in FIG. 11, the table 1100 comprises example data for workspace size estimation multi-target regression algorithm training. In this example, the targets to be predicted by the WSPE 1006 may comprise ‘Number of Containers,’ ‘Composite Size (milli CPU),’ and ‘Ephemeral Storage (MiB).’ Additional or alternative targets may be specified in other embodiments.

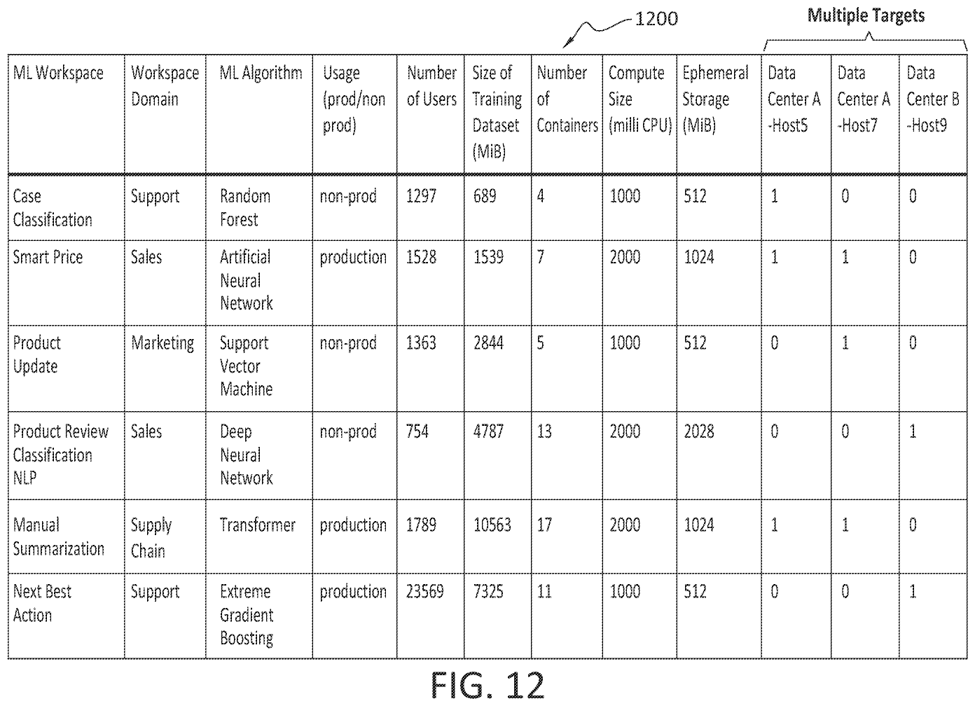

With reference now to FIG. 12, a table 1200 is disclosed that comprises example data for use by the DHPE 1010 in multi-label classification algorithm training. As shown in the sample data of the table 1200, the output of the first mode, that is, the targets from the table 1100, may be fed as input of the second model. That is, and as shown in the table 1200, the targets shown in table 1100 as predicted by the WSPE 1006, namely, ‘Number of Containers,’‘Composite Size (milli CPU),’ and ‘Ephemeral Storage (MiB),’ are shown as the last three input columns of table 1200. Put another way, ‘Number of Containers,’ ‘Composite Size (milli CPU),’ and ‘Ephemeral Storage (MiB),’ are target labels for the first model (WSPE 1006) training data and will be the output values of prediction by the WSPE 1006, but are the input variables, or the independent variables, for the second model (DHPE 1010) training while the ‘Datacenter’ and host names in table 1200 are the target labels for predictions generated by the DHPE 1010.

### C.2.3 Aspects of an Example WSPE

As noted earlier herein, a WSPE 1006 according to one embodiment of the invention may comprise a dynamic, and predictive approach for calculating the resource requirements, such as compute, memory, and storage, for example, required by a workspace. Such calculation may be performed, using an ML model, based on historical resource utilization of similar workspaces with similar features.

In more detail, in order to make such predictions for a workspace instance resource sizing, an embodiment of the invention may employ timestamped historical utilization data of each workspace, along with the features and requirements of each workspace, which may include the type of algorithm, dataset size, number of data dimension and class of learning. The hosted environment behavior may also be employed as a basis for making predictions as to workspace instance resource sizing and provisioning. Such hosted environment behavior, which may be captured by a logging system, may include, for example, infrastructure metrics such as CPU (central processing unit), memory, and storage utilization.

The timestamped historical utilization data may comprise, for example, the load, volume, and seasonality of the resource utilization, and are a good training indicator of the future resource utilization. By utilizing an ML algorithm comprising a neural network based multi-target regression algorithm, an embodiment of the invention may predict the size of each resource component for that workspace. Infrastructure orchestration tools such as Kubernetes, ECS, EKS, and PKS for example, may then use these predicted resource sizes as a basis for provisioning the initial workspace, as well as for creating new instances of containers/pods/VMs for auto-scaling. This capability may enable intelligent resource sizing at the time of workspace provisioning in an elastic auto-scaling environment that may scale resources up or down to meet changing workspace requirements.

Thus, an embodiment of the WSPE 1006 may predict, with relatively high accuracy, the optimal size of a new ML workspace based on a variety of features used in the training data set. Based on the complexity and dimensionality of the issue resolution data in the enterprise that requires the new workspace, an embodiment of the WSPE 1006 may comprise a deep neural network based multi-target regressor, capable of predicting various target variables for a workspace. Such target variables comprise, but are not limited to, [1] the number of containers, [2] compute or processing requirements for the workspace, and [3] ephemeral storage/memory of the containers. In an embodiment, the WSPE 1006 may implement a supervised learning approach and a multi-target or multi-output regression-based machine learning algorithm to predict the number of containers and the size of various resources of the workspace instance including compute and ephemeral storage.

To facilitate generation of the predictions, historical utilization metrics of the workspace and their hosting infrastructure, such as a container and host server for example, may be harvested from monitoring and logging systems in the environment where the workspace is provided, such as a cloud environment or on-prem environment for example. These historical metrics data will be used to train the model in the WSPE 1006.

Typically, regression algorithms use one or more independent variables and predict a single dependent variable. As an embodiment of the invention may involve multiple different resources in the host infrastructure, such as compute, storage, and the number of containers, the model of the WSPE 1006 may predict multiple different outputs, that is, the WSPE 1006 may comprise a multi-target/output model. In multi-target regression, the outputs may be dependent on the input, and also dependent upon each other. For example, the number of containers or memory utilization may sometimes dependent upon the CPU, and vice versa. This means that often the outputs are not independent of each other and may require a model that predicts both outputs together and each output contingent upon the other outputs. Building separate models, one for each output and then using the outputs of all models to predict all resource sizes may present implementation difficulties and performance concerns however. Thus, an embodiment of the invention employs the specific approach of multi-target regression.

There are various approaches and algorithms to achieve multi-target regression, and such algorithms may, or may not, be employed in an embodiment of the invention. Some algorithms have built-in support for multi-target outputs, while others do not. Algorithms that do not support multi-target regression may be used as a wrapper to achieve multi-output support. For example, regression algorithms such as Linear Regressor, KNN Regressor, Random Forest Regressor support multi-target predictions natively, whereas Support Vector Regressor or Gradient Boosting Regressors do not support multi-target predictions and need to be used in conjunction with a wrapper function such as the MultiOutputRegressor available in the multioutput package of SKLearn library. An instance of these algorithms may be fed to the MultiOutputRegressor function to create a model that is able to predict multiple output values.

### C.2.3.1 Detailed Discussion of Example Embodiment of a WSPE

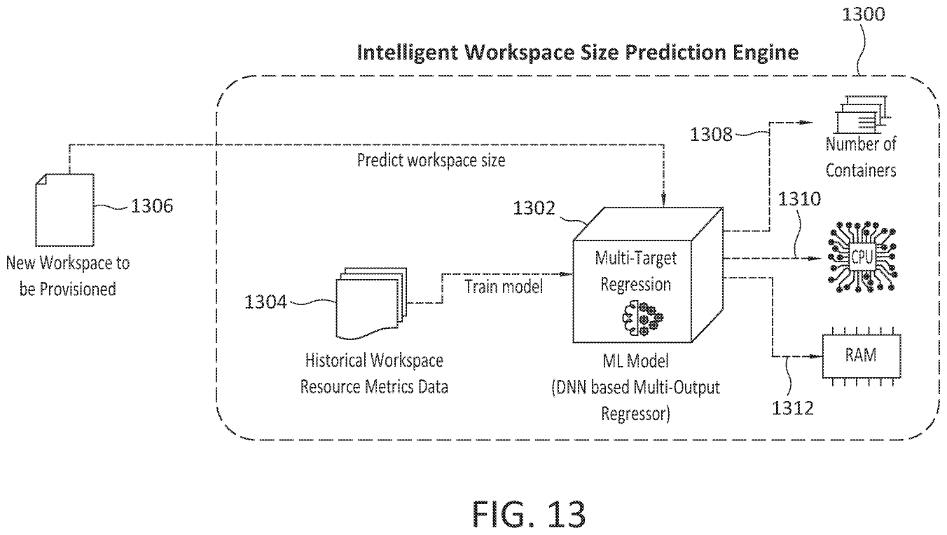

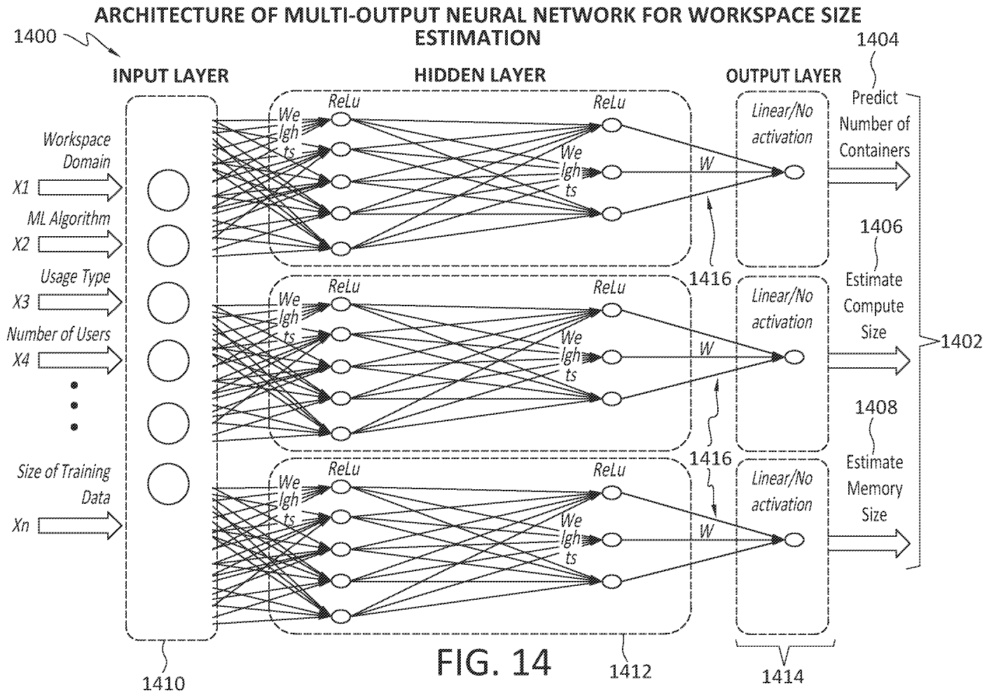

With attention now to FIG. 13, further details are provided concerning a WSPE 1300 according to one embodiment of the invention. As shown, the WSPE 1300 may comprise an ML model 1302, such as a workspace size prediction model for example, that uses multi-target regression to generate predictions of target variable values for one or more parameters of a workspace. Thus, in an embodiment, the ML model 1302 may comprise a DNN (deep neural network)-based multi-output regressor. Further details of such a DNN according to one embodiment of the invention are provided below in the discussion of FIG. 14.

With continued attention to FIG. 13, various inputs may be provided to the ML model 1302. One such input to the ML model 1302 may comprise information 1304, such as historical data/metadata about resource consumption in other workspaces. In an embodiment, the information 1304 may be used to train the ML model 1302. The trained ML model 1302 may then be used to make predictions as to the size, and resources, of a workspace needed by a user. Thus, a user may specify information 1306, such as workspace parameters, for a new workspace to be provisioned. As noted elsewhere herein, the parameters may be provided as part of a request by a user that a workspace size be predicted for an ML model that the user wishes to deploy. The ML model 1302 may then use the information 1306 provided by the user to make predictions as to various target variables of the workspace requested by the user. Thus, such predictions may comprise, by way of illustration but not limitation, a prediction 1308 as to the number of containers needed for the workspace, a prediction 1310 as to an amount of processing power, or CPU, needed for the workspace, and a prediction 1312 as to an amount of RAM needed for the workspace.

Due to the complexity and dimensionality of the data as well as the nature of multi-target prediction and estimation at the same time, an example embodiment comprises a DNN that has three parallel branches, all act as regressors for predicting, respectively, the number of containers, the estimated CPU, and estimated memory size of each container.

Turning now to FIG. 14, a DNN according to one example embodiment is denoted generally at 1400. The DNN 1400 may be implemented in, and perform the functions of, an ML model, such as the ML model 1302 discussed above. In an embodiment, the DNN 1400 may comprise a multi-output neural net comprises three parallel branches of network for three types of outputs 1402, such as a prediction 1404 as to the number of containers needed for the workspace a prediction 1406 as to an amount of processing power, or CPU, needed for the workspace, and a prediction 1408 as to an amount of RAM needed for the workspace.

By taking the same set of input variables through a single input layer 1410 the DNN 1400 provides parallel regressors, three in this example, for generating multi-output predictions. The example DNN 1400 comprises, in addition to the input layer 1410, one or more hidden layers 1412, two in this example, and an output layer 1414. In its implementation as a multi-output neural network, the DNN 1400 may comprise three separate branches 1416 of network, namely, two hidden layers 1412 and one output layer 1414, that all connect to the same input layer 1410.

In the example DNN 1400, the input layer 1410 comprises a number of neurons that matches the number of input/independent variables. Further, the hidden layer 1412 comprises two layers in the example architecture of the DNN 1400 and the neuron on each of the two layers in the hidden layer 1412 depends upon the number of neurons in the input layer 1410. The output layer 1414 for each branch 1416 may contain a different number of neurons, depending on the type of output used. But in the example of FIG. 14, all branches 1416 use just one neuron in each branch 1416. Since all the branches 1416 are configured as regressor branches, there will be one neuron for the output layer 1414, but linear or no activation function. The neurons in the hidden layers 1412 may use ReLu (rectified linear unit) activation for all three branches 1416.

### C.2.3.2 Aspects of an Example Method for Implementing and Using a WSPE

### C.2.3.2.1 Data Pre-Processing

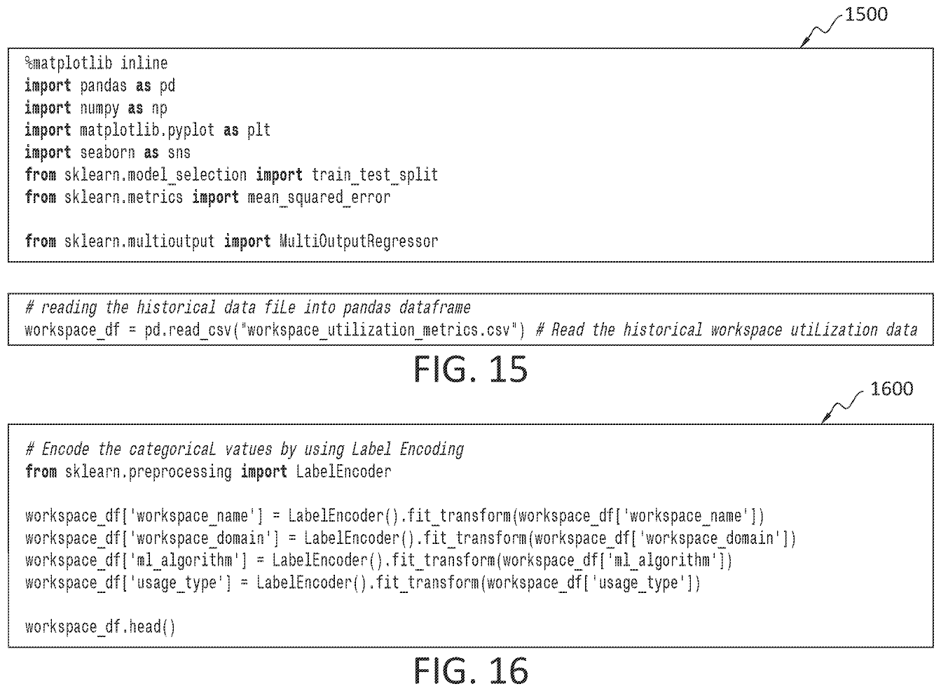

A method according to one embodiment may begin with data pre-processing. For example, a dataset of the of the historical workspace utilization data file may be read, and a Pandas data frame generated. The data frame may contain all the columns including independent variables, as well as both the dependent/target variable columns, namely, number of containers, compute requirements, and memory size. The initial operation may be to conduct pre-processing of data to handle any null or missing values in the columns. In an embodiment, null/missing values in numerical columns may be replaced by the median value of the values in that column. After performing an initial data analysis by creating univariate and bivariate plots of these columns, the importance and influence of each column may be understood. Columns that have no role or influence on the actual prediction, that is, on the target variables of [1] number of containers, [2] compute requirements, and [3] memory size, may be dropped. FIG. 15 discloses example code 1500 for generating a data frame such as that just described.

### C.2.3.2.2 Encoding

As ML models according to one or more embodiments of the invention may operate using numerical values, textual categorical values in the columns (see FIG. 11) of a dataset may be encoded. For example, categorical (textual) values such as ‘workspace domain,’ ‘ML algorithm,’ and ‘usage,’ may be encoded as numerical values. In an embodiment, the encoding may be performed using code 1600 disclosed in FIG. 16, such as LabelEncoder from ScikitLearn library, which is shown in FIG. 16.

### C.2.3.2.3 Dataset Splitting

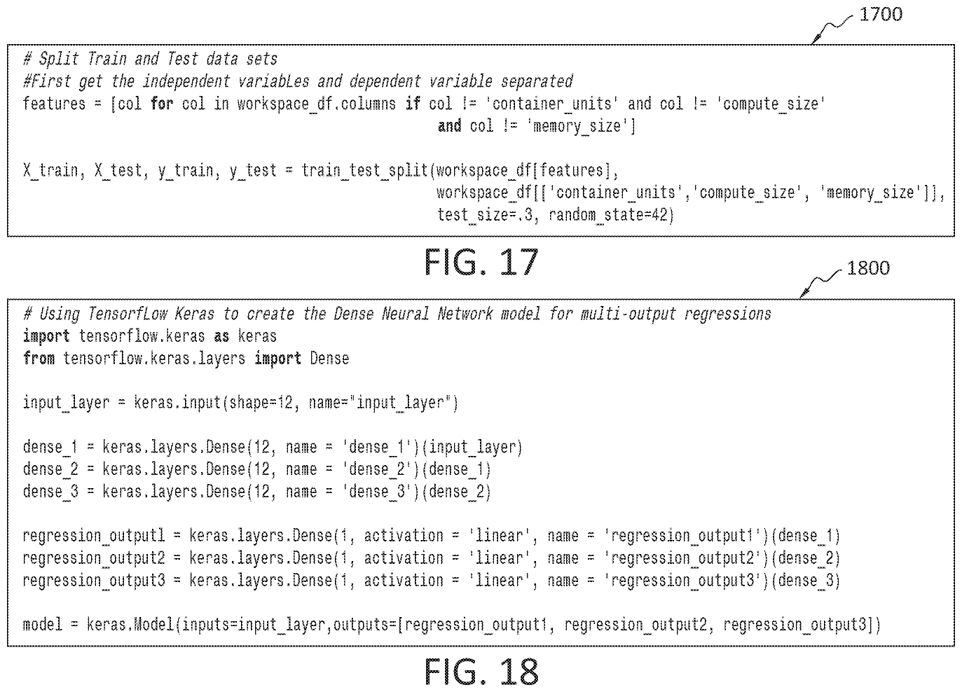

In an embodiment, a dataset to be used in connection with the generation of predictions as to parameters of a workspace may be split into a training dataset, and a testing dataset, using a train_test_split function of ScikitLearn library with 70%-30% split, as shown in the example code 1700 of FIG. 17. Since an embodiment may implement multi-target predictions (see table 1100 for example targets), it is useful to separate both the target variables from the dataset.

### C.2.3.2.4 NN (Neural Network) Model Creation

In an embodiment, a model, such as the model 1302 for example, may comprise a multi-layer, multi-output capable, DNN. In an embodiment, this DNN may be built using the Keras functional model, as separate branches may be created and added to the functional model. In an embodiment, three separate dense layers are added to the input layer, with each network being capable of predicting a different respective target, such as parameters of a workspace for example. Example code to build an embodiment of the DNN is indicated at 1800 in FIG. 18.

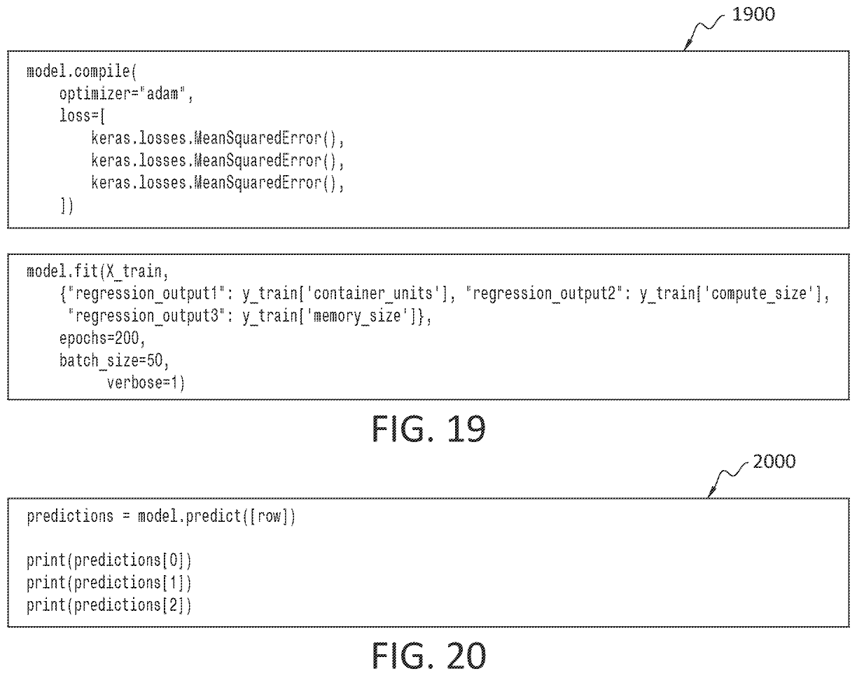

A model according to one embodiment may use “adam” as the optimizer and the “binary_crossentropy” as the loss function for both binary classification branches, that is, a branch that indicates either there is a security issue or not, and another branch that indicates either there is a performance issue or not. In an embodiment, the model may be trained with the training independent variables data X_train, and the target variables may be passed for each path, or classification. Example code for the model compile and training is denoted at 1900 in FIG. 19.

### C.2.3.2.5 Prediction Generation

Once the model is trained, the model may be directed to predict target values by passing independent variable values to the predict( ) of the model. For example, the model may be directed to predict, based on various inputs received by the model, various parameters of a workspace such as, for example, compute, number of containers, and memory. Example code for prediction generation is denoted at 2000 in FIG. 20.

### D. GENERAL ASPECTS OF AN EXAMPLE DHPE

As discussed earlier herein, an embodiment of the invention may comprise two steps, the first of which may be to identify an optimum workspace size and predict, based on the workspace size, workspace parameters such as compute, containers required, and memory. With all of this information, the second step may then be performed, which may comprise identifying an environment in which the workspace thus defined may be built. That is, the second step may comprise predicting an appropriate datacenter and host system in which to create the workspace.

These predicted workspace size metrics are used as input to the DHPE for predicting the data center host(s). As a workspace can span multiple hosts and even multiple datacenters, the DHPE may comprise a DNN-based, multi-label classification algorithm for predicting one or many hosts, and a datacenter that comprises the host, that a workspace may need. Beside the workspace size metrics predicted by a WSPE, various input variables, such as the type of customer ML algorithm to be used in the workspace, number of users, and size of training dataset, for example, may be used as inputs to the model of the DHPE.

### D.1 Detailed Discussion of Example Embodiment of a DHPE

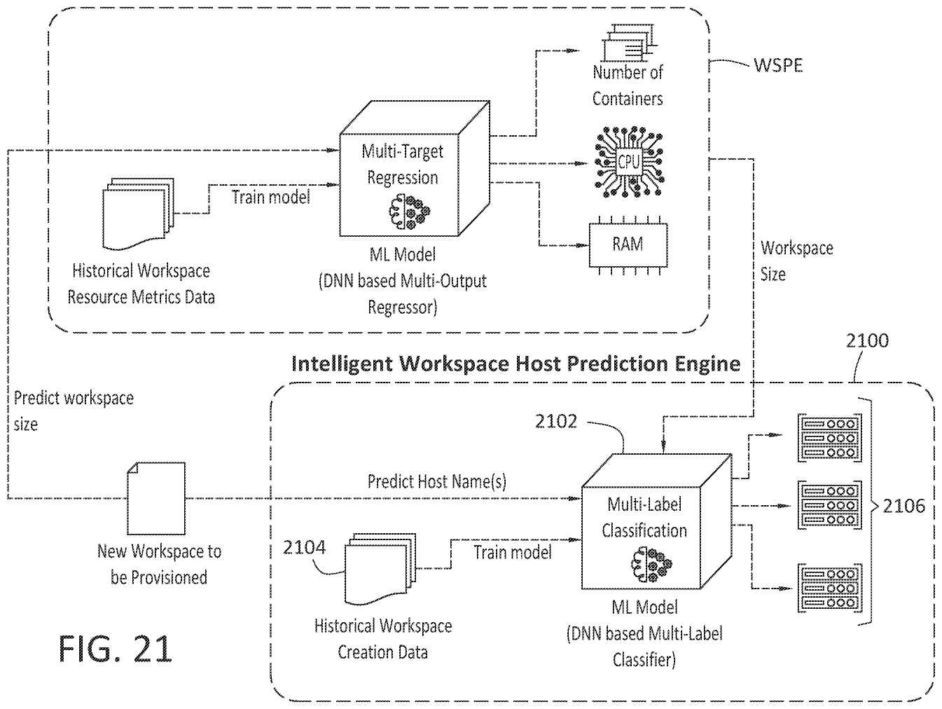

Turning now to FIG. 21, an embodiment of a DHPE according to one example embodiment is denoted generally at 2100. As shown there, the DHPE 2100 may comprise a model 2102 that performs a multi-label classification process. In an embodiment, the model 2102 comprises a DNN-based multi-label classifier. Various inputs may be provided to the model 2102 to facilitate the generation of predictions by the model 2102. One of such inputs may comprise workspace size and workspace provisioning information generated by a WSPE. Another of such inputs may comprise historical workspace creation data/metadata 2104, examples of which are disclosed in the table 1200. In an embodiment, the DHPE may predict a host name based on the identification, such as by a user or customer, of a new workspace that is to be provisioned. As shown in FIG. 21, and discussed in more detail below, the model 2102 may use the various inputs to generate predictions 2106 as to a host, or hosts, that may be suitable to host the workspace that was previously sized and provisioned. In an embodiment, a prediction 2106 may comprise identification of [1] a specific datacenter, and [2] a specific host within that datacenter. In an embodiment, a prediction 2106 may comprise multiple datacenters and/or multiple hosts.

With regard to classification algorithms, such as may comprise an element, or consist of, the model 2102, the classification algorithms may be predictive algorithms that predict, only, a single class label given some input. In the example case of a binary classification, a classification algorithm may predict one of two class options, while a multi-class algorithm may predict one of more than two class options. It is noted that in each of these cases, the algorithm predicts one class, making the classes as mutually exclusive, meaning that the classification task assumes that the input belongs to one class only. In an embodiment however, a workspace may span multiple hosts and, accordingly, the model 2102 may predict more than one class label. That is, in an embodiment, the class labels are not mutually exclusive. Thus, an embodiment of the invention may implement a multi-label classification scheme which is capable of predicting zero or more classes based on the input data received by the model 2102.

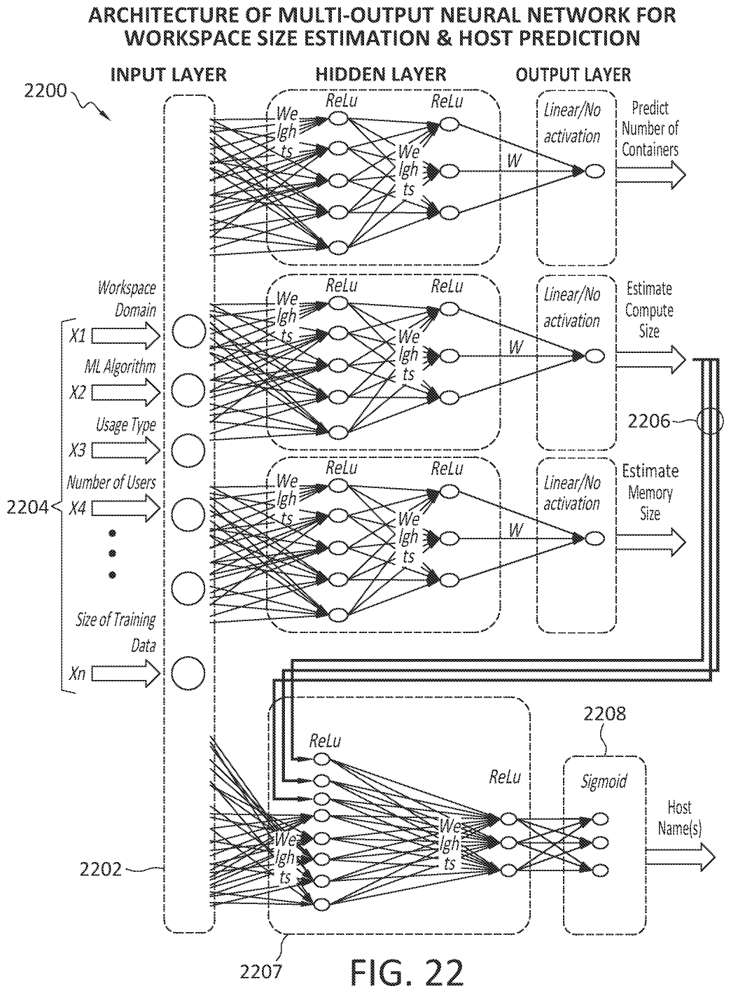

With reference now to FIG. 22, an example DHPE architecture according to one embodiment is denoted at 2200. In general, the example DHPE architecture 2200 may comprise a single input layer 2202 by way of which various inputs 2204 may be received to be used in a classification process. A hidden layer 2207 may receive, as inputs, both the inputs 2204, and outputs 2206 of a WSPE. An output layer 2208 may then output one or more host names of hosts that are able to support the workspace that was previously defined.

With regard to the DHPE architecture 2200, some machine learning classifications support multi-label classification natively, but NN models may be created and configured to support multi-label classification and perform well. Thus, a multi-layer classifier, such as may comprise an element, or consist, of a model such as the model 2102, may comprise an NN to perform classification operations. In an embodiment, multi-label classification may be supported directly by an NN by specifying the number of target labels there is in the problem as the number of nodes in the output layer 2208.

For example, if there are three hosts that may be used to create workspaces, the associated classification task has three output labels, or classes, and may thus require an NN output layer with three nodes in the output layer 2208. Each node in the output layer 2208 may use the sigmoid activation function and the model 2102 may be fit with the binary cross_entropy loss function. In the example data shown in table 1200, there are three datacenter host classes as targets, namely, DatacenterA-Host5, DatacenterA-Host7, and DatacenterB-Host.

### D.2 Aspects of an Example Method for Implementing and Using a DHPE

In an embodiment, implementation of a DHPE may performed using Keras with Tensorflow backend, Python language, Pandas, Numpy & ScikitLearn libraries. Further details concerning an example implementation of a DHPE are set forth below.

### D.2.1 Data Pre-Processing

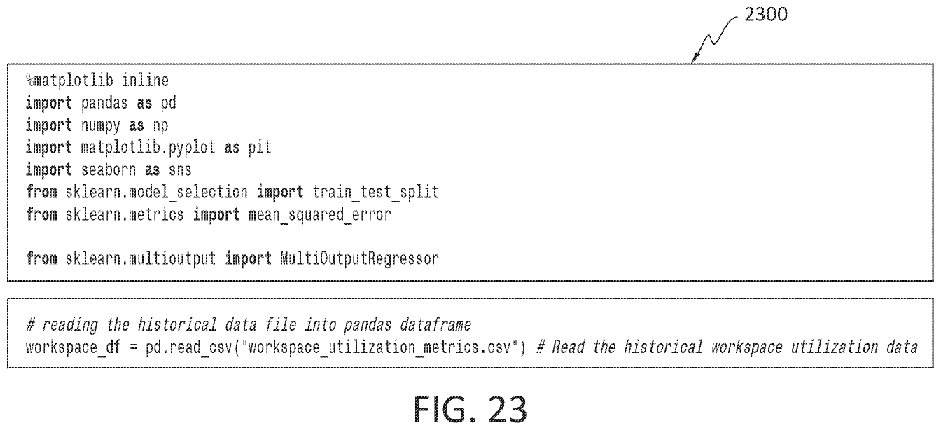

A method according to one embodiment may begin with data pre-processing. For example, a dataset of the of the historical workspace utilization data file may be read, and a Pandas data frame generated. The data frame may contain all the columns including independent variables, as well as both the dependent/target variable columns, namely, ‘n’ hosts. The initial operation may be to conduct pre-processing of data to handle any null or missing values in the columns. In an embodiment, null/missing values in numerical columns may be replaced by the median value of the values in that column. After performing an initial data analysis by creating univariate and bivariate plots of these columns, the importance and influence of each column may be understood. Columns that have no role or influence on the actual prediction, that is, on the target variable of host names, may be dropped. FIG. 23 discloses example code 2300 for generating a data frame such as that just described.

### D.2.2 Importation of Packages/Libraries, and Loading Historical Datasets

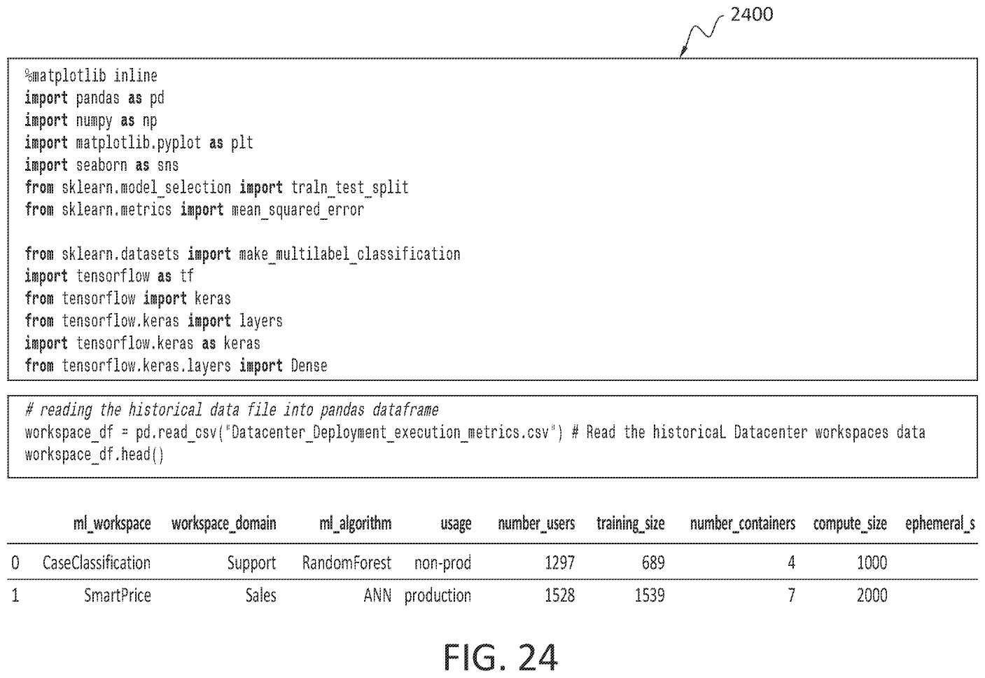

FIG. 24 discloses example code 2400 for importing packages and libraries for data engineering, data pre-processing, label encoding, and model building activities, and also discloses example code for loading a historical dataset that includes information about the datacenter(s) where workspaces were previously deployed, and information concerning execution and telemetry of those workspaces.

### D.2.3 Encoding

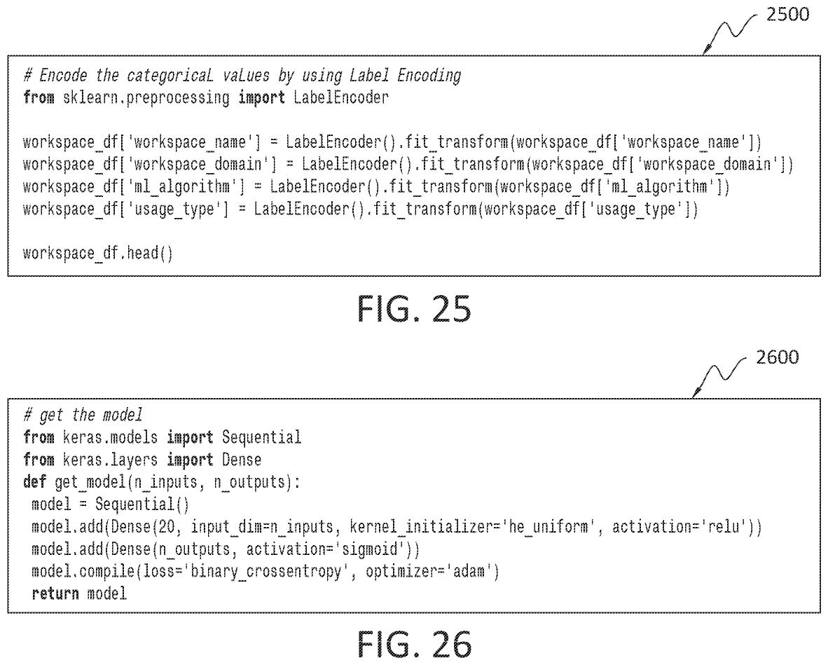

As ML models according to one or more embodiments of the invention may operate using numerical values, textual categorical values in the columns (see FIG. 12) of a dataset may be encoded. For example, categorical (textual) values such as ‘workspace domain,’ ‘ML algorithm,’ and ‘usage,’ may be encoded as numerical values. In an embodiment, the encoding may be performed using code 2500 disclosed in FIG. 25, such as LabelEncoder from ScikitLearn library, which is shown in FIG. 25.

### D.2.4 NN Model Creation

In an embodiment, a multi-layer, multi-label capable dense NN may be created using the Keras library. In an embodiment, an NN is built using Keras Sequential function. The NN uses an “ReLu” activation function in the input layer while “sigmoid” activation is used in the output layer. Binary cross entropy is used as the loss function and “adam” is used as the optimizer. Example code 2600 to build such an NN is disclosed in FIG. 26.

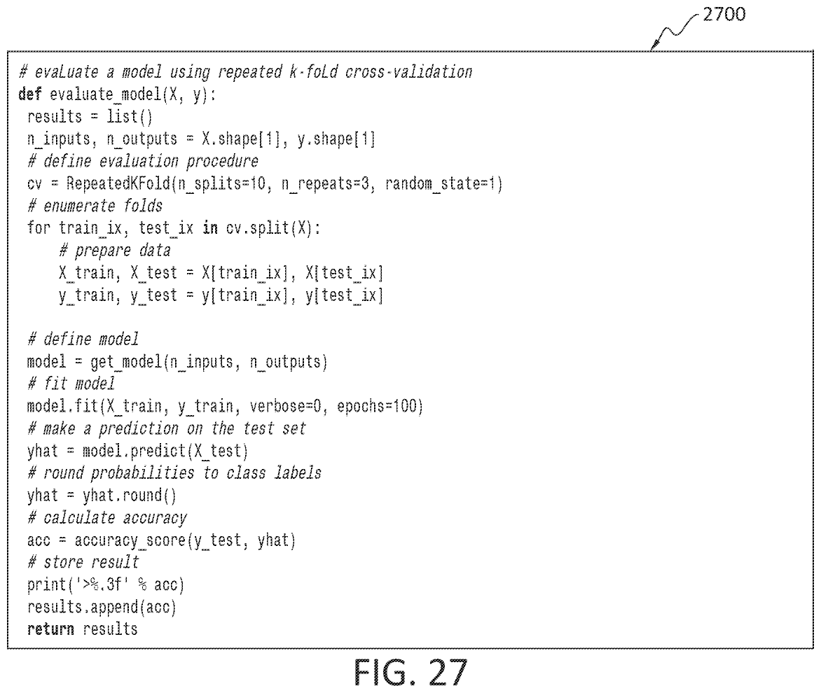

One example embodiment uses a k-fold cross validation instead of train_test_split of the training data. This approach may help in obtaining an unbiased estimate of model performance when making predictions on new data. An embodiment may comprise an evaluate_model function that takes the data (both X and y) and trains the model, evaluates the model by prediction and returns accuracy scores. Example code 2700 for such a model evaluation is disclosed in FIG. 27.

### E. FURTHER DISCUSSION

As apparent from this disclosure, example embodiments of the invention may possess various useful aspects and features. Some examples of these follow.

For example, an embodiment comprises an intelligent capacity management framework for provisioning ML workspaces in shared hybrid cloud platforms by predicting the size as well as the right environment, thus automates the process of provisioning for optimal performance, scalability, and growth.

As another example, an embodiment may formulate programmatically, and with a high degree of accuracy, predict the actual resource size, such as compute, ephemeral storage, and containers, of an ML workspace hosting instance, such as a container, pod, or VM (virtual machine) for example, by leveraging a DNN-based multi-target regressor algorithm, and training the algorithm using the historical utilization data of similar workspaces with similar features and requirements.

In a final example, an embodiment of the invention may intelligently identify the characteristics, such as CPU bound, I/O bound, and memory bound, of the workspace being provisioned and schedule, or place, the workspace in an appropriate environment capable of supporting the workspace. These characteristics of the workspace may be identified using a DNN-based classification algorithm and training the classification algorithm with the historical workspace provisioning data of similar workspace characteristics.

### F. EXAMPLE METHODS

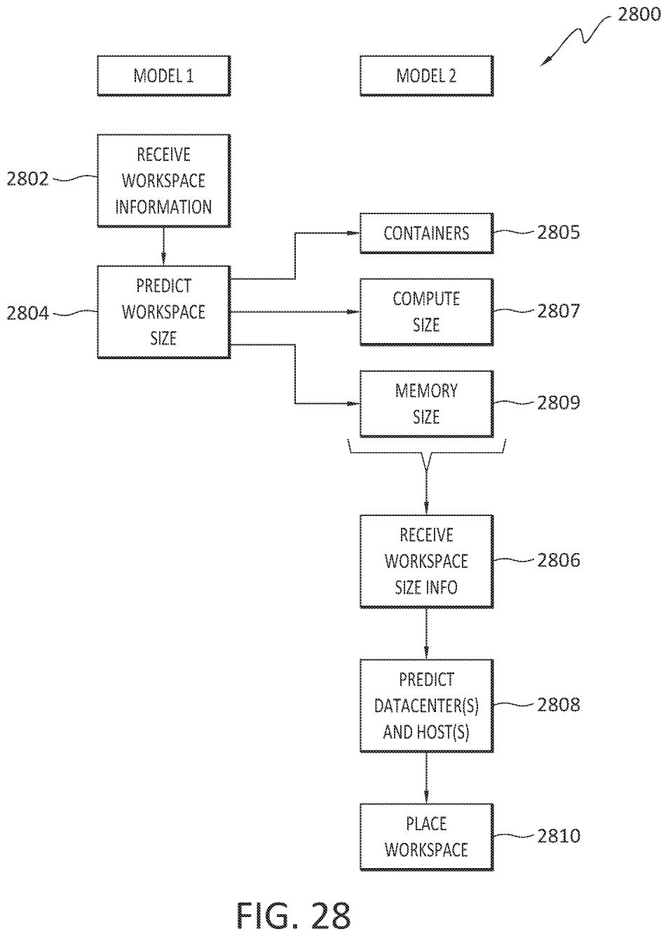

It is noted with respect to the disclosed methods, including the example method of FIG. 28, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 28, a method according to one example embodiment is denoted generally at 2800. In an embodiment, one part of the method 2800 may be performed by a workspace size prediction engine (WSPE), and another part of the method 2800 may be performed by a datacenter host prediction engine (DHPE).

The method 2800 may begin with receipt of workspace information 2802 by a WSPE. In an embodiment, the workspace information may be received 2802 as part of a request, by a user or customer, for the provisioning of a workspace that will host a customer ML model. The workspace information may comprise various parameters, and respective values, specified by the user for the workspace for which provisioning has been requested. In an embodiment, the workspace may be a cloud native workspace.

The WSPE may then use the workspace information that was received 2802 to generate a workspace size prediction 2804. In an embodiment, the workspace size prediction may be made in terms of resources expected to be needed in the workspace to support operation of the customer ML model. Thus, a workspace size prediction according to one example embodiment may comprise information such as the number of containers 2805 needed in the workspace, a processing capacity 2807 of the workspace, and an amount of memory 2809 needed in the workspace.

The workspace size prediction, which is an output of the WSPE, may then be provided as an input to the DHPE. Thus, the DHPE may receive 2806 the workspace size prediction from the WSPE. The workspace size prediction information may then be used by the DHPE to predict 2808 a host and/or datacenter that is able to support the requirements of the workspace.

Finally, the workspace may be placed 2810 on the host/datacenter that was identified 2808. Because the workspace size, and capability of the host, have been verified in advance, the owner or customer of the ML model may have assurance that the ML model will be able to run as needed in the workspace. In an embodiment, the method 2800 may be applied to an existing workspace, that is, a modified workspace size may be predicted, and a corresponding host/datacenter predicted for the modified workspace size. In this way, for example, adjustments may be made to the workspace size based on changing requirements of the customer ML model, and/or changes in the workspace environment.

### G. FURTHER EXAMPLE EMBODIMENTS

Following are some further example embodiments of the invention. These are presented only by way of example and are not intended to limit the scope of the invention in any way.

Embodiment 1. A method, comprising: receiving, by a workspace size predicting engine, a workspace provisioning request regarding a customer machine learning (ML) model; predicting, by the workspace size predicting engine, a size of a workspace that corresponds to the workspace provisioning request; receiving, by a datacenter host prediction engine from the workspace size predicting engine, the workspace size; and predicting, by the datacenter host prediction engine, a datacenter and/or host that is able to support requirements of the workspace.

Embodiment 2. The method as recited in any preceding embodiment, wherein the workspace size comprises a number of containers, and a respective amount of memory and processing capability for each of the containers.

Embodiment 3. The method as recited in any preceding embodiment, wherein the workspace size prediction engine provides the workspace size to a workspace provisioning engine that provisions the workspace using the workspace size.

Embodiment 4. The method as recited in any preceding embodiment, wherein the workspace size prediction engine comprises a deep neural network (DNN)-based multi-output regressor that uses multi-target regression to predict the size of the workspace.

Embodiment 5. The method as recited in any preceding embodiment, wherein the workspace size prediction engine was trained based in part using historical workspace resource metrics data.

Embodiment 6. The method as recited in any preceding embodiment, wherein the host prediction engine comprises a deep neural network (DNN)-based multi-output regressor that uses multi-target regression to predict the datacenter and/or host.

Embodiment 7. The method as recited in any preceding embodiment, wherein the host prediction engine was trained based in part using historical workspace creation data.

Embodiment 8. The method as recited in any preceding embodiment, wherein the host prediction engine comprises DNN-based multi-label classifier.

Embodiment 9. The method as recited in any preceding embodiment, wherein the workspace is provisioned, based on the workspace size, in a shared hybrid cloud platform.

Embodiment 10. The method as recited in any preceding embodiment, wherein the workspace is placed in the predicted host and/or datacenter.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

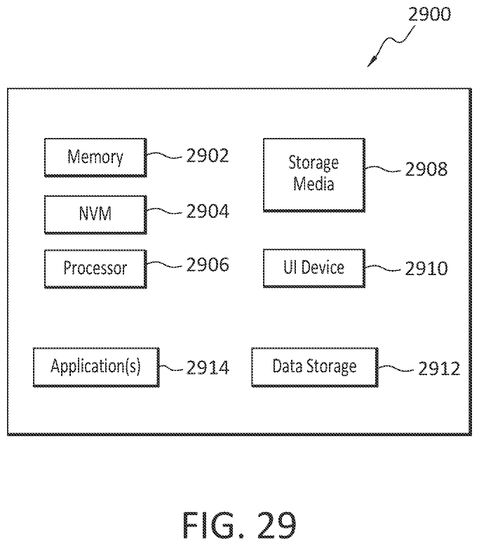

With reference briefly now to FIG. 29, any one or more of the entities disclosed, or implied, by FIGS. 1-28, and/or elsewhere herein, may take the form of, or include, or be implemented on, or hosted by, a physical computing device, one example of which is denoted at 2900. As well, where any of the aforementioned elements comprise or consist of a virtual machine (VM), that VM may constitute a virtualization of any combination of the physical components disclosed in FIG. 29.

In the example of FIG. 29, the physical computing device 2900 includes a memory 2902 which may include one, some, or all, of random access memory (RAM), non-volatile memory (NVM) 2904 such as NVRAM for example, read-only memory (ROM), and persistent memory, one or more hardware processors 2906, non-transitory storage media 2908, UI device 2910, and data storage 2912. One or more of the memory components 2902 of the physical computing device 2900 may take the form of solid state device (SSD) storage. As well, one or more applications 2914 may be provided that comprise instructions executable by one or more hardware processors 2906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

### I. GLOSSARY

| Term | Definition |
|---|---|
| DevOps | DevOps is a methodology to improve collaboration and |
| | automation. Its end goal is to release software faster and |
| | more efficiently. |
| Jobs | Kubernetes Job creates one or more Pods and will continue to |
| | retry execution of the Pods until a specified number of them |
| | successfully terminate. As pods successfully complete, the |
| | Job tracks the successful completions. |
| Private | A private cloud serves the needs of a single organization. It |
| cloud | may bey hosted on-prem. |
| Public | A public cloud is hosted by a cloud provider such as Amazon |
| cloud | Web Services (AWS), Microsoft Azure, or Google Cloud |
| | Platform. It provides on-demand cloud services. |
| Micro- | A new software design architecture that breaks apart monolithic |
| services | systems into loosely coupled services which can be developed, |
| | deployed, and maintained independently. |
| Queue | In computing terms, queue is a collection of entities maintained |
| | in a FIFO(First In First Out) sequence and can be modified with |
| | addition of entities at one end of the sequence and removal of |
| | entities from the other end. |
| CronJob | A CronJob creates Jobs on a repeating schedule. |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a workspace size predicting engine, a workspace provisioning request regarding a customer machine learning (ML) model;
predicting, by the workspace size predicting engine, a size of a workspace that corresponds to the workspace provisioning request;
receiving, by a datacenter host prediction engine from the workspace size predicting engine, the workspace size; and
predicting, by the datacenter host prediction engine, a datacenter and/or host that is able to support requirements of the workspace.

2. The method as recited in claim 1, wherein the workspace size comprises a number of containers, and a respective amount of memory and processing capability for each of the containers.

3. The method as recited in claim 1, wherein the workspace size prediction engine provides the workspace size to a workspace provisioning engine that provisions the workspace using the workspace size.

4. The method as recited in claim 1, wherein the workspace size prediction engine comprises a deep neural network (DNN)-based multi-output regressor that uses multi-target regression to predict the size of the workspace.

5. The method as recited in claim 1, wherein the workspace size prediction engine was trained based in part using historical workspace resource metrics data.

6. The method as recited in claim 1, wherein the host prediction engine comprises a deep neural network (DNN)-based multi-output regressor that uses multi-target regression to predict the datacenter and/or host.

7. The method as recited in claim 1, wherein the host prediction engine was trained based in part using historical workspace creation data.

8. The method as recited in claim 1, wherein the host prediction engine comprises DNN-based multi-label classifier.

9. The method as recited in claim 1, wherein the workspace is provisioned, based on the workspace size, in a shared hybrid cloud platform.

10. The method as recited in claim 1, wherein the workspace is placed in the predicted host and/or datacenter.

11. A non-transitory storage medium having stored therein instructions that are executable by one or more hardware processors to perform operations comprising:
receiving, by a workspace size predicting engine, a workspace provisioning request regarding a customer machine learning (ML) model;
predicting, by the workspace size predicting engine, a size of a workspace that corresponds to the workspace provisioning request;
receiving, by a datacenter host prediction engine from the workspace size predicting engine, the workspace size; and
predicting, by the datacenter host prediction engine, a datacenter and/or host that is able to support requirements of the workspace.

12. The non-transitory storage medium as recited in claim 11, wherein the workspace size comprises a number of containers, and a respective amount of memory and processing capability for each of the containers.

13. The non-transitory storage medium as recited in claim 11, wherein the workspace size prediction engine provides the workspace size to a workspace provisioning engine that provisions the workspace using the workspace size.

14. The non-transitory storage medium as recited in claim 11, wherein the workspace size prediction engine comprises a deep neural network (DNN)-based multi-output regressor that uses multi-target regression to predict the size of the workspace.

15. The non-transitory storage medium as recited in claim 11, wherein the workspace size prediction engine was trained based in part using historical workspace resource metrics data.

16. The non-transitory storage medium as recited in claim 11, wherein the host prediction engine comprises a deep neural network (DNN)-based multi-output regressor that uses multi-target regression to predict the datacenter and/or host.

17. The non-transitory storage medium as recited in claim 11, wherein the host prediction engine was trained based in part using historical workspace creation data.

18. The non-transitory storage medium as recited in claim 11, wherein the host prediction engine comprises DNN-based multi-label classifier.

19. The non-transitory storage medium as recited in claim 11, wherein the workspace is provisioned, based on the workspace size, in a shared hybrid cloud platform.

20. The non-transitory storage medium as recited in claim 11, wherein the workspace is placed in the predicted host and/or datacenter.
